(19) United States
(12) Patent Application Publication
(10) Pub. No.: US 2024/0172022 A1
(43) Pub. Date: May 23, 2024

(54) SYSTEMS AND METHODS FOR PERFORMING LOCATION INFORMATION ON MEASUREMENT GAP

(71) Applicant: ZTE Corporation, Shenzhen (CN)

(72) Inventors: Guozeng ZHENG, Shenzhen (CN); Chuangxin JIANG, Shenzhen (CN); Yansheng LIU, Shenzhen (CN); Yu PAN, Shenzhen (CN); Zhaohua LU, Shenzhen (CN); Hao WU, Shenzhen (CN)

(73) Assignee: ZTE Corporation, Shenzhen (CN)

(21) Appl. No.: 18/347,709

(22) Filed: Jul. 6, 2023

Related U.S. Application Data
(63) Continuation of application No. PCT/CN2021/092978, filed on May 11, 2021.

(51) Int. Cl. H04W 24/10; H04W 64/00

(52) U.S. Cl. CPC H04W 24/10; H04W 64/00

(57) ABSTRACT

A wireless communication method includes requesting, by a wireless communication entity, user equipment (UE) to provide location information; and providing, by the wireless communication entity, a measurement gap to a wireless communication node or the UE.

### CROSS-REFERENCE TO RELATED APPLICATION

This application claims the benefit of priority under 35 U.S.C. § 120 as a continuation of PCT Patent Application No. PCT/CN2021/092978, filed on May 11, 2021, the disclosure of which is incorporated herein by reference in its entirety.

### TECHNICAL FIELD

The disclosure relates generally to wireless communications and, more particularly, to systems and methods for performing location information on measurement gap.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

In some embodiments, Location Management Function (LMF) performs a method including requesting User Equipment (UE) to provide location information; and providing a measurement gap to a Base Station (BS) or the UE.

In some embodiments, a UE performs a method receiving, from the LMF, a request to provide location information; and receiving, from the LMF, a measurement gap.

In some embodiments, a BS performs a method receiving, from the LMF, a request to provide location information; and receiving, from the LMF, a measurement gap.

In other embodiments, a wireless communications apparatus comprising a processor and a memory, wherein the processor is configured to read code from the memory and implement a method including requesting UE to provide location information; and providing a measurement gap to a BS or the UE.

In other embodiments, a computer program product comprising a computer-readable program medium code stored thereupon, the code, when executed by a processor, causing the processor to implement a method including requesting UE to provide location information; and providing a measurement gap to a BS or the UE.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is s a flowchart diagram illustrating an example wireless communication method for providing measurement gap information, according to various embodiments.

FIG. 1B is s a flowchart diagram illustrating an example wireless communication method for receiving measurement gap information, according to various embodiments.

FIG. 1C is s a flowchart diagram illustrating an example wireless communication method for receiving measurement gap information, according to various embodiments.

FIG. 2A illustrates a block diagram of an example Location Management Function, according to various embodiments.

FIG. 2B illustrates a block diagram of an example device, according to various embodiments.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

In current 5G New Radio (NR) systems, positioning procedures are subject to large delays that limit the scenarios in which the technology can be applied. In general, serving NR Node B (gNB) and neighbor gNBs provide configured Downlink (DL) Positioning Reference Signals (PRS) to a Location Management Function (LMF) via New Radio Positioning Protocol (NRPPa) in a Transmission and Reception Point (TRP) INFORMATION RESPONSE message. Prior to this procedure, the TRP (or gNB-Distributed Unit (DU)) may also provide configured DL PRS to a corresponding gNB (or gNB-Central Unit (CU)) via F1 Application Protocol (FLAP) in a TRP INFORMATION RESPONSE message.

From there, the LMF provides DL PRS configuration forwarded by gNBs to User Equipment (UE) via Long Term Evolution (LTE) Positioning Protocol (LPP) in a ProvideAssistanceData message. The DL PRS configuration includes the following information: 1) the LMF configures one or more positioning frequency layers, which are collections of DL PRS resource sets across one or more TRPs that have the same Sub-Carrier Spacing (SCS), Cyclic Prefix (CP), center frequency, reference frequency, configured Bandwidth (BW), and/or comb size; 2) one or more TRPs that are configured under each frequency layer, which is identified by TRP-ID information; 3) one or more DL PRS Resource Sets that are configured under each TRP, which is identified by DL PRS resource set ID; and 4) one or more DL PRS resources that are configured within a DL PRS resource set, which is identified by DL PRS resource ID.

Next, the LMF requests the UE to provide a location information report based on the DL PRS configuration in a ProvideAssistanceData message. The request message is sent via LPP in a RequestLocationlnformation message. The UE then requests measurement gaps for performing the requested location measurements/information if measurement gaps are either not configured or not sufficient. The request signaling is transmitted from the UE to serving gNB via Radio Resource Control (RRC) signaling. Upon receipt, the serving gNB configures measurement gaps (if necessary) to the UE via RRC signaling. From there (or from the original LMF request if measurement gaps were not necessary), the UE conducts positioning measurements within the configured measurement gaps based on DL PRS configuration in ProvideAssistanceData message and according to the RequestLocationlnformation message, and forwards the location information report to LMF via LPP in a ProvideLocationlnformation message.

The systems and methods described herein enhance the current procedures for measurement gap request and configuration. Under current procedure, the UE may require measurement gaps for performing the requested location measurements/information while measurement gaps are either not configured or not sufficient. In current 5G NR positioning systems, the measurement gap request increases positioning latency. In order to address these shortcomings, the LMF may suggest, request, or determine the measurement gaps for the UE to perform positioning measurements/information since LMF has the information that what kinds of DL PRS that the UE has to measure, thereby removing the responsibility to request measurement gaps from the UE.

In the all following embodiments, LMF can also be a wireless communication entity that has similar functionalities as LMF. Serving gNB (or neighbor gNB) can be also a wireless communication node (e.g. Next Generation Radio Access Network (NG-RAN) node).

First, the LMF may need to know the UE's measurement gap-related capabilities (or capability information of the UE for determining the measurement gap) so that the LMF can determine how to suggest, request, or determine the measurement gaps. This can be accomplished by the LMF requesting the UE's measurement gap-related capabilities according to one of two embodiments. In a first embodiment, the serving gNB provides the UE's measurement gap-related capabilities to the LMF over NRPPa. The serving gNB may also provide frequency information of serving cells and corresponding BWPs (or only active BWPs) of the UE to the LMF over NRPPa. In a second embodiment, the UE itself provides the UE's measurement gap-related capabilities to the LMF over LPP. The UE may also provide frequency information of serving cells and corresponding BWPs (or only active BWPs) of the UE to the LMF over LPP. In either embodiment, the UE's measurement gap-related capabilities include at least one of: a) supportedGapPattern, which indicates the measurement gap pattern(s) optionally supported by the UE; b) independentGapConfig, which indicates whether the UE supports two independent measurement gap configurations for a first Frequency Range (FR1) and a second FR (FR2); or c) interFrequencyMeas-NoGap, which indicates whether the UE can perform inter-frequency Synchronization Signal Block (SSB)-based measurements without measurement gaps if the SSB is completely contained in the active BWP of the UE. Before this procedure, the LMF may request either the serving gNB or UE to provide the UE's measurement gap-related capabilities.

Second, the UE may have to perform other measurement aside from positioning measurements, such that the UE may have already been pre-configured (or previously configured) with measurement gap(s). As such, the LMF may need to know whether the UE has been pre-configured with measurement gap(s), and if so, what the pre-configured measurement gap is. From this, the LMF can determine whether the pre-configured measurement gap is sufficient.

The UE may provide information regarding the pre-configured measurement gap configurations to the LMF by serving gNB over NRPPa (or the UE over LPP). The pre-configured measurement gap configuration further includes at least one of: a) Measurement Gap Length (MGL) of the measurement gap; b) Measurement Gap Repetition Period (MGRP) of the measurement gap; c) the gap offset of the measurement gap pattern indicated by the MGL and MGRP; or d) the Measurement Gap Timing Advance (MGTA). Before this procedure, the LMF may request either the serving gNB or UE to provide pre-configured measurement gap configurations.

Another message related to the pre-configured measurement gap configurations may also be provided by the serving gNB over NRPPa (or by the UE over LPP). The another message may include at least one of: a) an indication that no measurement gap has been configured for the UE; b) an indication that pre-configured measurement gap configurations have been configured for the UE, but the pre-configured measurement gap configurations cannot be applied to positioning/location measurements purpose; or c) an indication that pre-configured measurement gap configurations have been configured for the UE and the pre-configured measurement gap configurations can be applied to positioning/location measurements. However, the pre-configured measurement gap configurations are not sufficient for positioning/location measurements.

The UE or serving gNB may also provide configurations of reference signals to LMF. These reference signals include at least one of a) SSB (Synchronization Signal and PBCH Block); b) CSI-RS (Channel State Information Reference Signal)(e.g, CSI_RS for mobility); or c) reference signals for deriving location information report of ECID (Enhanced Cell ID). This information would help the LMF decide whether the pre-configured measurement gap configurations are sufficient.

Third, the LMF may suggest, request, or determine a measurement gap configuration to facilitate the UE's receipt of positioning reference signals. In a first embodiment, the LMF suggests at least one suggested measurement gap configuration to the serving gNB over NRPPa, and the serving gNB then decides whether to use the at least one suggested measurement gap configuration. The suggested measurement gap configuration includes at least one of: a) MGL of the measurement gap; b) MGRP of the measurement gap; c) the measurement gap offset of the measurement gap pattern indicated by MGL and MGRP; or d) the MGTA.

In a second embodiment, the LMF requests at least one requested measurement gap configuration to the serving gNB over NRPPa, and the serving gNB decides how to use at least one requested measurement gap configuration. The requested measurement gap configuration includes at least one of: a) an Absolute Radio Frequency Channel Number (ARFCN) value; b) a measurement gap periodicity and offset of the requested location measurement gap for performing location measurements/information; or c) a measurement gap length of the requested measurement gap for performing location measurements/information. Each requested measurement gap configuration may correspond to a positioning frequency layer.

In a third embodiment, the LMF determines at least one measurement gap configuration and forwards the at least one measurement gap configuration for the UE to perform location measurements/information by one of: a) the LMF provides the measurement gap configuration to serving gNB over NRPPa, and the serving gNB then provides the measurement gap configuration to the UE over RRC signaling; or b) the LMF provides the measurement gap configuration to serving gNB over NRPPa and also informs the UE of the measurement gap configuration over LPP. The measurement gap configuration includes at least one of: a) MGL of the measurement gap; b) MGRP of the measurement gap; c) the gap offset of the measurement gap pattern indicated by MGL and MGRP; or d) the MGTA.

Fourth, the LMF may receive a response message (or a first message) from serving gNB over NRPPa (or by the UE over LPP). The response message includes at least one of: a) confirming that the measurement gap provided by LMF has been configured for the UE; or b) providing at least a measurement gap configuration determined by the serving gNB for the UE.

Fifth, the LMF may provide the UE's measurement gap-related capabilities (or capability information of the UE for determining the measurement gap), the pre-configured measurement gap configurations, or the measurement gap configurations to neighbor gNBs over NRPPa. The neighbor gNB (or gNB-CU) may provide the UE's measurement gap-related capabilities, pre-configured measurement gap configurations, or measurement gap configurations to associated TRPs (or gNB-DU) via F1AP. This information may facilitate neighbor gNBs and associated TRPs to configure DL PRS. The LMF may receive, either from the serving gNB over NRPPa or UE over LPP, frequency information of serving cell(s) in the UE, which may further include frequency information regarding BWPs (or only active BWPs) of the serving cells of the UE. From there, the LMF may also provide frequency information for serving cells and corresponding BWPs (or only active BWPs) of the UE to neighbor gNBs over NRPPa. The neighbor gNBs (or gNB-CU) may then provide frequency information of serving cells and corresponding BWPs (or only the active BWPs) of the UE to associated TRPs (or gNB-DU) via F1AP.

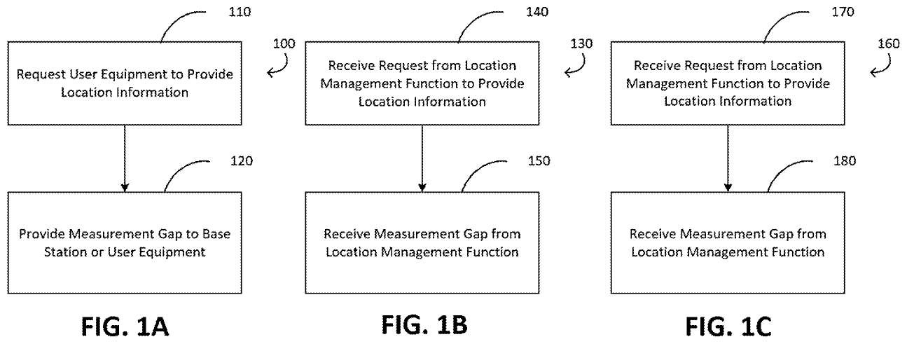

FIG. 1A is a flowchart diagram illustrating an example wireless communication method 100, according to various arrangements. Method 100 can be performed by a Location Management Function (LMF), and begins at 110 where the LMF requests User Equipment (UE) to provide location information. At 120, the LMF provides a measurement gap to a Base Station (BS) or the UE.

In some embodiments, the method 100 further comprises receiving, from the BS or UE, capability information of the UE for determining the measurement gap. In other embodiments, the method 100 further comprises requesting that the BS or UE provides capability information of the UE for determining the measurement gap. In further embodiments, the method 100 further comprises receiving a previously configured measurement gap for the UE. In still further embodiments, the method 100 further comprises receiving configurations of reference signals that include at least one of Synchronization Signal and PBCH Block (SSB) or Channel State Information Reference Signal (CSI-RS).

In some embodiments, the measurement gap includes at least a portion of a measurement gap configuration. In some of these embodiments, the measurement gap configuration includes at least one of: a) a Measurement Gap Length (MGL) of the measurement gap; b) a Measurement Gap Repetition Period (MGRP) of the measurement gap; c) a gap offset of a measurement gap pattern indicated by the MGL and MGRP; or d) a Measurement Gap Timing Advance (MGTA). In other of these embodiments, the measurement gap configuration includes at least one of: a) an Absolute Radio Frequency Channel Number (ARFCN) value; b) a measurement gap periodicity and offset of the measurement gap for performing location information; or c) a measurement gap length of the measurement gap for performing location information.

In some embodiments, the method 100 further comprises receiving, from the BS or UE, a response message that includes at least one of: a) confirming that the measurement gap provided by the LMF has been configured for the UE; orb) providing a measurement gap configuration determined by the BS for the UE. In other embodiments, the method 100 further comprises providing, to a neighbor BS, a message that includes at least one of: a) a measurement gap configuration for the UE; b) capability information of the UE for determining the measurement gap; or c) previously configured measurement gap for the UE.

In some embodiments, the method 100 further comprises receiving, from the BS or the UE, frequency information of at least one serving cell of the UE. In some of these embodiments, the frequency information of the at least one serving cell of the UE includes frequency information of one or more Bandwidth Parts (BWPs) of the at least one serving cell of the UE. In other of these embodiments, the method 100 further comprises providing, to a neighbor gNB, frequency information of the at least one serving cell of the UE.

FIG. 1B is a flowchart diagram illustrating an example wireless communication method 130, according to various arrangements. Method 130 can be performed by a User Equipment (UE), and begins at 140 where the UE receives a request from a Location Management Function (LMF) to provide location information. At 150, the UE receives a measurement gap from the LMF.

In some embodiments, the method 130 further comprises providing capability information of the UE to the LMF for determining the measurement gap. In other embodiments, the method 130 further comprises providing configurations of reference signals to the LMF. The reference signals include at least one of SSB (Synchronization Signal and PBCH Block) or CSI-RS (Channel State Information Reference Signal).

In some embodiments, the measurement gap includes at least a portion of a measurement gap configuration. In some of these embodiments, the measurement gap configuration includes at least one of: a) a measurement gap length (MGL) of the measurement gap; b) a measurement gap repetition period (MGRP) of the measurement gap; c) a measurement gap offset of the measurement gap pattern indicated by the MGL and the MGRP; or d) a measurement gap timing advance (MGTA). In other of these embodiments, the measurement gap configuration includes at least one of: a) an Absolute Radio Frequency Channel Number (ARFCN) value; b) a measurement gap periodicity and offset of the measurement gap for performing the location information; or c) a measurement gap length of the measurement gap for performing the location information.

In some embodiments, the method 130 further comprises transmitting to the LMF a message that includes at least one of: a) confirming that the measurement gap provided by the LMF has been configured for the UE; or b) providing at least a measurement gap configuration determined by a Base Station (BS) for the UE.

In some embodiments, the method 130 further comprises transmitting, to the LMF, frequency information of at least one serving cell of the UE. In some of these embodiments, the frequency information of serving cells of the UE includes frequency information of Bandwidth Parts (BWPs) of the at least one serving cell of the UE.

FIG. 1C is a flowchart diagram illustrating an example wireless communication method 160, according to various arrangements. Method 160 can be performed by a Base Station (BS), and begins at 170 where the BS receives a request from a Location Management Function (LMF) to provide a location information. At 180, the BS receives a measurement gap from the LMF.

In some embodiments, the method 160 further comprises providing, to the LMF, capability information of a user equipment (UE) for determining the measurement gap. In other embodiments, the method 160 further comprises providing configurations of reference signals that include at least one of SSB (Synchronization Signal and PBCH Block) or CSI-RS (Channel State Information Reference Signal).

In some embodiments, the measurement gap includes at least a portion of a measurement gap configuration. In some of these embodiments, the measurement gap configuration includes at least one of: a) a measurement gap length (MGL) of the measurement gap; b) a measurement gap repetition period (MGRP) of the measurement gap; c) a measurement gap offset of the measurement gap pattern indicated by the MGL and the MGRP; or d) a measurement gap timing advance (MGTA). In other of these embodiments, the measurement gap configuration includes at least one of: a) an Absolute Radio Frequency Channel Number (ARFCN) value; b) a measurement gap periodicity and offset of the measurement gap for performing the location measurement; or c) a measurement gap length of the measurement gap for performing the location measurement.

In some embodiments, the method 160 further comprises transmitting, to the LMF, a message that includes at least one of: a) confirming that the measurement gap provided by the LMF has been configured for the UE; or b) providing at least a measurement gap configuration determined by the BS for the UE.

In some embodiments, the method 160 further comprises transmitting, to the LMF, frequency information of at least one serving cell of the UE. In some of these embodiments, the frequency information of the at least one serving cell of the UE includes frequency information of Bandwidth Parts (BWPs) of the at least one serving cell of the UE.

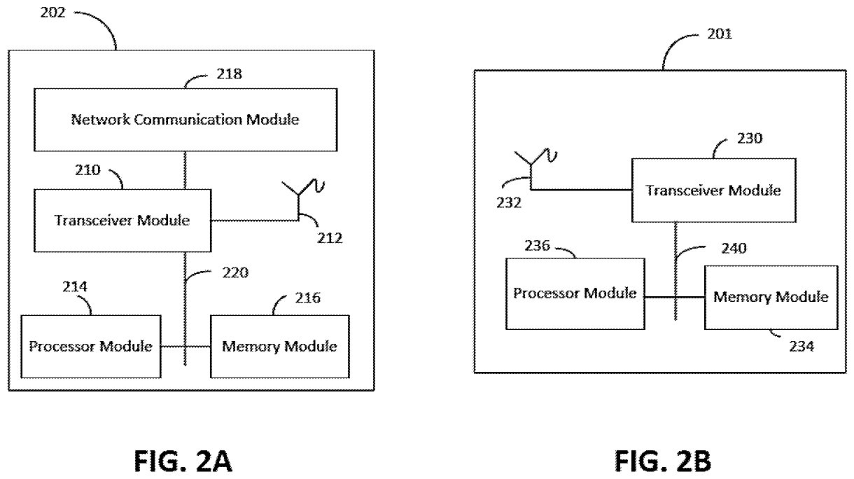

FIG. 2A illustrates a block diagram of an example LMF 202, in accordance with some embodiments of the present disclosure. FIG. 2B illustrates a block diagram of an example device 201, in accordance with some embodiments of the present disclosure. The device 201 may be a UE (e.g., a wireless communication device, a terminal, a mobile device, a mobile user, and so on) which is an example implementation of the UEs described herein, or may be a BS, (e.g., network, serving gNB, etc.) which is an example implementation of the BS described herein.

The LMF 202 and the device 201 can include components and elements configured to support known or conventional operating features that need not be described in detail herein. In one illustrative embodiment, the LMF 202 and the device 201 can be used to communicate (e.g., transmit and receive) data symbols in a wireless communication environment, as described above. For instance, the LMF 202 can be a server, a node, or any suitable computing device used to implement various network functions.

The LMF 202 includes a transceiver module 210, an antenna 212, a processor module 214, a memory module 216, and a network communication module 218. The module 210, 212, 214, 216, and 218 are operatively coupled to and interconnected with one another via a data communication bus 220. The device 201 includes a device transceiver module 230, a device antenna 232, a device memory module 234, and a device processor module 236. The modules 230, 232, 234, and 236 are operatively coupled to and interconnected with one another via a data communication bus 240. The LMF 202 communicates with the device 201 or another device via a communication channel, which can be any wireless channel or other medium suitable for transmission of data as described herein.

As would be understood by persons of ordinary skill in the art, the LMF 202 and the device 201 can further include any number of modules other than the modules shown in FIGS. 2A and 2B. The various illustrative blocks, modules, circuits, and processing logic described in connection with the embodiments disclosed herein can be implemented in hardware, computer-readable software, firmware, or any practical combination thereof. To illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. The embodiments described herein can be implemented in a suitable manner for each particular application, but any implementation decisions should not be interpreted as limiting the scope of the present disclosure.

In accordance with some embodiments, the device transceiver 230 includes a radio frequency (RF) transmitter and a RF receiver each including circuitry that is coupled to the antenna 232. A duplex switch (not shown) may alternatively couple the RF transmitter or receiver to the antenna in time duplex fashion. Similarly, in accordance with some embodiments, the transceiver 210 includes an RF transmitter and a RF receiver each having circuitry that is coupled to the antenna 212 or the antenna of another BS. A duplex switch may alternatively couple the RF transmitter or receiver to the antenna 212 in time duplex fashion. The operations of the two-transceiver modules 210 and 230 can be coordinated in time such that the receiver circuitry is coupled to the antenna 232 for reception of transmissions over a wireless transmission link at the same time that the transmitter is coupled to the antenna 212. In some embodiments, there is close time synchronization with a minimal guard time between changes in duplex direction.

The device transceiver 230 and the transceiver 210 are configured to communicate via the wireless data communication link, and cooperate with a suitably configured RF antenna arrangement 212/232 that can support a particular wireless communication protocol and modulation scheme. In some illustrative embodiments, the device transceiver 230 and the transceiver 210 are configured to support industry standards such as the Long Term Evolution (LTE) and emerging 5G standards, and the like. It is understood, however, that the present disclosure is not necessarily limited in application to a particular standard and associated protocols. Rather, the device transceiver 230 and the LMF transceiver 210 may be configured to support alternate, or additional, wireless data communication protocols, including future standards or variations thereof.

The transceiver 210 and the transceiver of another device (such as but not limited to, the transceiver 210) are configured to communicate via a wireless data communication link, and cooperate with a suitably configured RF antenna arrangement that can support a particular wireless communication protocol and modulation scheme. In some illustrative embodiments, the transceiver 210 and the transceiver of another BS are configured to support industry standards such as the LTE and emerging 5G standards, and the like. It is understood, however, that the present disclosure is not necessarily limited in application to a particular standard and associated protocols. Rather, the transceiver 210 and the transceiver of another device may be configured to support alternate, or additional, wireless data communication protocols, including future standards or variations thereof.

In accordance with various embodiments, the device 201 may be a BS such as but not limited to, an eNB, a serving eNB, a target eNB, a femto station, or a pico station, for example. The device 201 can be an RN, a DeNB, or a gNB. In some embodiments, the device 201 may be a UE embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the method or algorithm disclosed herein can be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 214 and 236, respectively, such that the processors modules 214 and 236 can read information from, and write information to, memory modules 216 and 234, respectively. The memory modules 216 and 234 may also be integrated into their respective processor modules 214 and 236. In some embodiments, the memory modules 216 and 234 may each include a cache memory for storing temporary variables or other intermediate information during execution of instructions to be executed by processor modules 214 and 236, respectively. Memory modules 216 and 234 may also each include non-volatile memory for storing instructions to be executed by the processor modules 214 and 236, respectively.

The network communication module 218 generally represents the hardware, software, firmware, processing logic, and/or other components of the LMF 202 that enable bi-directional communication between the transceiver 210 and other network components and communication nodes in communication with the LMF 202. For example, the network communication module 218 may be configured to support internet or WiMAX traffic. In a deployment, without limitation, the network communication module 218 provides an 502.3 Ethernet interface such that the transceiver 210 can communicate with a conventional Ethernet based computer network. In this manner, the network communication module 218 may include a physical interface for connection to the computer network (e.g., Mobile Switching Center (MSC)). In some embodiments, the network communication module 218 includes a fiber transport connection configured to connect the LMF 202 to a core network. The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
sending, by a wireless communication entity, a first request to a user equipment (UE) to provide location information; and
providing, by the wireless communication entity, a measurement gap to a wireless communication node or the UE.

2. The method of claim 1, further comprising:
receiving, by the wireless communication entity from the wireless communication node or the UE, capability information of the UE for determining the measurement gap.

3. The method of claim 2, further comprising:
sending, by the wireless communication entity, a second request to the wireless communication node or the UE, to provide capability information of the UE for determining the measurement gap.

4. The method of claim 1, further comprising:
receiving, by the wireless communication entity or the UE, a previously configured measurement gap for the UE.

5. The method of claim 1, further comprising:
receiving, by the wireless communication entity, configurations of reference signals, wherein the reference signals include at least one of SSB (Synchronization Signal and PBCH Block) or CSI-RS (Channel State Information Reference Signal).

6. The method of claim 1, wherein the measurement gap includes at least a portion of a measurement gap configuration.

7. The method of claim 6, wherein the measurement gap configuration includes at least one of:
a measurement gap length (MGL) of the measurement gap;
a measurement gap repetition period (MGRP) of the measurement gap;
a measurement gap offset of the measurement gap pattern indicated by the MGL and the MGRP; or
a measurement gap timing advance (MGTA).

8. The method of claim 6, wherein the measurement gap configuration includes at least one of:
an Absolute Radio Frequency Channel Number (ARFCN) value;
a measurement gap periodicity and offset of the measurement gap for performing the location information; or
a measurement gap length of the measurement gap for performing the location information.

9. The method of claim 1, further comprising:
receiving, by the wireless communication entity from the wireless communication node or the UE, a first message;
wherein the first message is configured to at least one of:
confirm that the measurement gap provided by the wireless communication entity has been configured for the UE; or
provide at least a measurement gap configuration determined by the wireless communication node for the UE.

10. The method of claim 1, further comprising:
providing, by the wireless communication entity to a neighbor wireless communication node, a second message,
wherein the second message includes at least one of:
at least a measurement gap configuration for the UE;
capability information of the UE for determining the measurement gap; or
a previously configured measurement gap for the UE.

11. The method of claim 1, further comprising:
receiving, by the wireless communication entity from the wireless communication node or the UE, frequency information of at least one serving cell of the UE.

12. The method of claim 11, wherein the frequency information of the at least one serving cell of the UE includes frequency information of one or more Bandwidth Parts (BWPs) of the at least one serving cell of the UE.

13. The method of claim 11, further comprising:
providing, by the wireless communication entity to a neighbor wireless communication node, frequency information of the at least one serving cell of the UE.

14. A wireless communication method, comprising:
receiving, by a user equipment (UE) from a wireless communication entity, a request to provide location information; and
receiving, by the UE from the wireless communication entity, a measurement gap.

15. A user equipment (UE), comprising:
at least one processor configured to:
receive, via a receiver from a wireless communication entity, a request to provide location information; and
receive, via the receiver from the wireless communication entity, a measurement gap.

16. A wireless communication entity, comprising:
at least one processor configured to:
send, via a transceiver. a first request to a user equipment (UE) to provide location information; and
provide, via the transceiver, a measurement gap to a wireless communication node or the UE.

17. The wireless communication entity of claim 16, wherein the at least one processor is configured to:
receive, via the transceiver from the wireless communication node or the UE, capability information of the UE for determining the measurement gap.

18. The wireless communication entity of claim 17, wherein the at least one processor is configured to:
send, via the transceiver, a second request to the wireless communication node or the UE to provide capability information of the UE for determining the measurement gap.

19. The wireless communication entity of claim 16, wherein the at least one processor is configured to:
receive, via the transceiver, a previously configured measurement gap for the UE.

20. The wireless communication entity of claim 16, wherein the at least one processor is configured to:
receive, via the transceiver, configurations of reference signals, wherein the reference signals include at least one of SSB (Synchronization Signal and PBCH Block) or CSI-RS (Channel State Information Reference Signal).
